(19) United States
(12) Patent Application Publication
(10) Pub. No.: US 2001/0006386 A1
(43) Pub. Date: Jul. 5, 2001

(54) Navigation device and device for generating navigation device

(76) Inventors: Shinichirou Araki, Tokyo (JP); Yousuke Asai, Tokyo (JP); Koji Hashimoto, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/725,143

(22) Filed: Nov. 29, 2000

(30) Foreign Application Priority Data
Nov. 30, 1999 (JP) 11-340983

(51) Int. Cl. G06F 17/00; G06F 3/00

(52) U.S. Cl. 345/418

(57) ABSTRACT

A navigation device performs navigation services for users and displays a navigation image. The navigation device is divided into the following four modules: an application unit for performing navigation services based on information from an external unit; an application control unit for controlling the application unit according to an internal state of the navigation device; a screen control unit for controlling display of the navigation image according to an instruction from the application unit; and a screen display unit for displaying the navigation image according to an instruction from the screen control unit.

### BACKGROUND OF THE INVENTION

1. Field of the Invention

The present invention relates to a navigation device that performs navigation services, and displays a navigation image, and a device for generating a navigation device.

1. Description of the Prior Art

FIG. 22 is a block diagram showing the structure of a prior art device for generating a navigation device. In the figure, reference numeral 201 denotes a graphical user interface (GUI) builder screen which is a screen generated under development of a screen generating program, and numeral 202 denotes a GUI builder unit for displaying a GUI builder screen 201 in a display not shown in the figure based on GUI, for designing one or more GUI screens with an editor unit 211 considering restrictions defined by a restriction description unit 203 with a restriction imposing unit 212 according to an operation performed on an input device not shown in the figure, and for finally generating one or more screen generating programs 204 with a program generation unit 213. Restrictions defined by users based on a GUI guideline etc. are described in the restriction description unit 203.

In operation, a user can design a GUI screen by operating the input device not shown in the figure while seeing a GUI builder screen 201 displayed on the screen of the display not shown in the figure. The GUI builder unit 202 forms the GUI screen according to an operation performed on the input device by the user considering the restrictions defined by the restriction description unit 203, and displays a GUI screen etc. at that time on the screen of the display as a GUI builder screen 201. A screen generating program 204 corresponding to the GUI screen is generated and is output when the design of the GUI screen ends.

A problem with a prior art device for generating a navigation device constructed as above is that though it can generate one or more screen generating programs, users should create a program concerning control of the internal state of the navigation device or the like with a usual text editor, and it is therefore difficult for a person who does not have the knowledge of the programming to develop any navigation device.

Furthermore, it is necessary to prepare a development environment according to the hard-ware configuration of a navigation device to be developed, and to create a program constructing the development environment, and it takes much time to prepare such a development environment. In addition, it is difficult to debug the program, and, therefore, it is difficult to improve the efficiency of development of navigation devices.

### SUMMARY OF THE INVENTION

The present invention is proposed to solve the above-mentioned problems, and it is therefore an object of the present invention to provide a navigation device whose functionality is divided into four modules: an application control unit for performing navigation services based on information from an external unit; an application control unit for controlling the application unit according to the internal state of the navigation device; a screen control unit for controlling display of a navigation image according to an instruction from the application unit; and a screen display unit for displaying the navigation image according to an instruction from the screen control unit, thereby making it possible for users to easily develop the navigation device.

It is a further object of the present invention to provide a program generation device for navigation devices, provided with an application control unit generating means for generating an application control unit to perform navigation services based on information from an external unit; a screen control unit generating means for generating a screen control unit to control display of a navigation image according to an instruction from the application unit; and a display data generating means for generating screen data to make it possible for a screen display unit to display the navigation image with the screen data according to an instruction from the screen control unit, thereby making it possible for even a person who does not have the knowledge of the programming to develop a navigation device, and providing a development environment which does not depend on the hardware configuration of the navigation device.

In accordance with an aspect of the present invention, there is provided a navigation device for performing navigation services, and for displaying a navigation image, the navigation device being divided into the following four modules: an application unit for performing navigation services based on information from an external unit; an application control unit for controlling the application unit according to an internal state of the navigation device; a screen control unit for controlling display of the navigation image according to an instruction from the application unit; and a screen display unit for displaying the navigation image according to an instruction from the screen control unit.

In accordance with a preferred embodiment of the present invention, the application unit is connected with the external unit by way of a network.

In accordance with another preferred embodiment of the present invention, the screen control unit can transfer an instruction to the application control unit by using either an event queue or a call function, the application control unit can transfer an instruction to the application unit by using either an event queue or a call function, the application unit can transfer an instruction to the screen control unit by using an event queue, and the screen control unit can transfer an instruction to the screen display unit by using an event queue.

In accordance with a further aspect of the present invention, there is provided a generation device for generating a navigation device, characterized in that the generation device comprises: a first generation unit for generating an application control unit for controlling an application unit, which performs navigation services based on information from an external unit, according to an internal state of the navigation device; a second generation unit for generating a screen control unit for controlling display of a navigation image according to an instruction from the application unit; and a third generation unit for generating screen data for a screen display unit for displaying the navigation image with the screen data according to an instruction from the screen control unit.

In accordance with a preferred embodiment of the present invention, the device further comprises a fourth generation unit for generating the application unit for performing navigation services based on information from the external unit.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the hardware configuration of a navigation device according to a first embodiment of the present invention;

FIG. 2 is a block diagram showing the structure of the navigation device according to the first embodiment;

FIG. 3 is a block diagram showing the structure of screen data of FIG. 2;

FIG. 4 is a block diagram showing the structure of a screen control unit of the navigation device shown in FIG. 2;

FIG. 5 is a block diagram showing the structure of an application control unit of the navigation device shown in FIG. 2;

FIG. 6 is a block diagram showing the structure of an application of the navigation device shown in FIG. 2;

FIG. 7 is a block diagram showing transfer of an instruction between two of a screen display unit, the screen control unit, the application, and the application control unit, which is carried out using an event queue;

FIG. 8 is a block diagram showing transfer of an instruction between two of the screen display unit, the screen control unit, the application, and the application control unit, which is carried out using either an event queue or a call function;

FIG. 9 is a flow chart explaining the operation of the navigation device according to the first embodiment;

FIG. 10 is a block diagram showing the structure of a generation device for generating a navigation device according to a second embodiment;

FIG. 11 is a block diagram showing the structure of a screen data generation device of the creation device shown in FIG. 10;

FIG. 12 is a block diagram showing the structure of a screen control unit generation device of the creation device shown in FIG. 10;

FIG. 13 is a block diagram showing the structure of an application control unit generation device of the creation device shown in FIG. 10;

FIG. 14 is a block diagram showing the structure of a screen data/screen control unit generation device in which the screen data generation device and the screen control unit generation device of FIG. 10 are integrated;

FIG. 15 is a flow chart explaining the operation of the screen data generation device;

FIG. 16 is a flow chart explaining the operation of the screen control unit generation device;

FIG. 17 is a flow chart explaining the operation of the application control unit generation device;

FIG. 18 is a block diagram showing the structure of a generation device for generating a navigation device according to a third embodiment;

FIG. 19 is a block diagram showing the structure of an application generation device of the creation device shown in FIG. 18;

FIG. 20 is a flow chart explaining the operation of the application generation device;

FIG. 21 is a block diagram showing the structure of a generation device for generating a navigation device according to a fourth embodiment; and

FIG. 22 is a block diagram showing the structure of a prior art generation device for generating a navigation device.

### DETAILED DESCRIPTION OF THE PREFERRED EMBODIMENTS

Embodiment 1

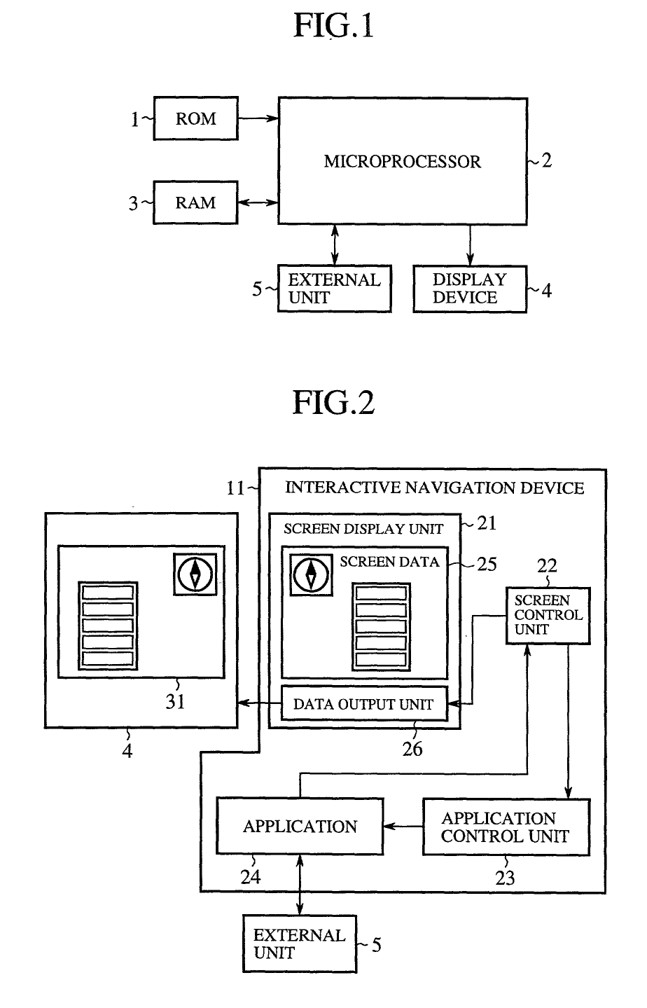

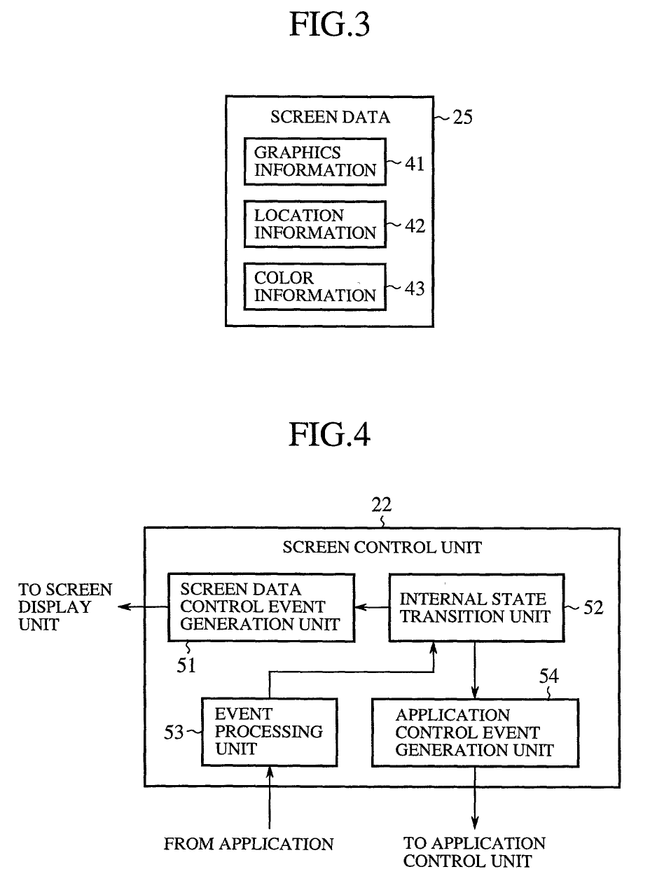

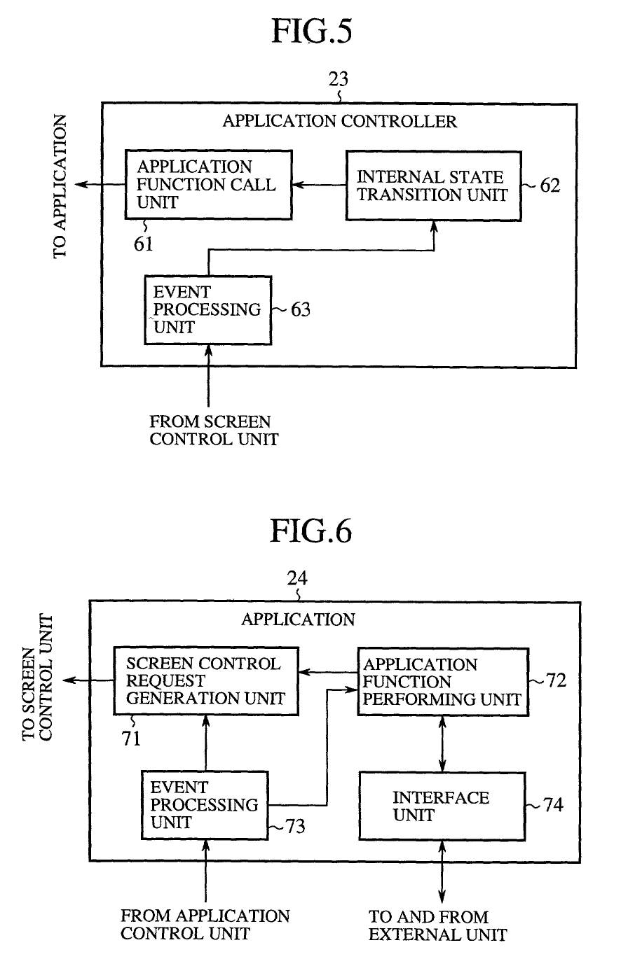

FIG. 1 is a block diagram showing the hardware configuration of a navigation device according to a first embodiment of the present invention, and FIG. 2 is a block diagram showing the structure of the navigation device according to the first embodiment. FIG. 3 is a block diagram showing the structure of screen data of FIG. 2, FIG. 4 is a block diagram showing the structure of a screen control unit of FIG. 2, FIG. 5 is a block diagram showing the structure of an application control unit of FIG. 2, and FIG. 6 is a block diagram showing the structure of an application of FIG. 2.

In FIG. 1, reference numeral 1 denotes a ROM for storing a program divided, in advance, into the following four modules; an application control unit for controlling an application according to the internal state of the navigation device, an application unit (i.e., application) for performing navigation services based on an instruction from the application control unit and one or more pieces of information from an external unit (for example, current position information from a GPS receiver, speed information from a speed sensor, information on operations performed by the user from a remote controller, etc.), a screen control unit for controlling display of a navigation image according to an instruction from the application, and a screen display unit for displaying a navigation image with screen data, according to an instruction from the screen control unit. Reference numeral 2 denotes a microprocessor for reading the program from the ROM 1 into a RAM 3, and for performing various processes according to the program, the RAM 3 temporarily storing the program and data at execution of the program by the microprocessor 2, numeral 4 denotes a display, such as a liquid crystal display, for displaying a navigation image, and numeral 5 denotes the external unit including such devices as a GPS (Global Positioning System) receiver, a speed sensor, a remote controller, etc.

In FIG. 2, reference numeral 11 denotes an interactive navigation device that is implemented by the execution of the program by the microprocessor 2. In the interactive navigation device 11, reference numeral 21 denotes the above-mentioned screen display unit having screen data 25 and a data output unit 26 for displaying a navigation image with the screen data 25 on a screen 31 of the display 4 according to an instruction from the above-mentioned screen control unit 22 for controlling the display of the navigation image according to an instruction from the application 24, and numeral 23 denotes the above-mentioned application control unit for controlling the above-mentioned application 24 according to the internal state of the navigation device. The application 24 performs navigation services based on an instruction from the application control unit 23 and one or more pieces of information from the external unit 5.

In the screen data 25 shown in FIG. 3, reference numeral 41 denotes graphics information showing the outlines of a plurality of image components, such as basic graphics and bitmaps, numeral 42 denotes location information showing the locations of the plurality of image components, and numeral 43 denotes color information showing the colors of the plurality of image components.

In the screen control unit 22 shown in FIG. 4, reference numeral 51 denotes a screen data control event generation unit for supplying an event to control the screen data to the screen display unit 21 according to an instruction from an internal state transition unit 52 for causing the internal state of the screen control unit 22 to transition according to an instruction from an event processing unit 53, and for supplying an instruction associated with the transition to the screen data control event generation unit 51 and an application control event generation unit 54. The event processing unit 53 receives an event from the application 24, and then supplies an instruction associated with the event to the internal state transition unit 52. The application control event generation unit 54 supplies an event to control the application to the application control unit 23 according to the instruction from the internal state transition unit 52.

In the application control unit 23 shown in FIG. 5, reference numeral 61 denotes an application function call unit for supplying an event to cause the application 24 to perform a function to the application 24 according to an instruction from an internal state transition unit 62 for causing the internal state of the application control unit 23 to transition according to an instruction from an event processing unit 63, and for supplying an instruction associated with the transition to the application function call unit 61. The event processing unit 63 receives an event from the screen control unit 22, and supplies an instruction associated with the event to the internal state transition unit 62.

In the application 24 shown in FIG. 6, reference numeral 71 denotes a screen control request generation unit for supplying such an instruction as one to update a navigation image on-screen to the screen control unit 22 according to an instruction from either an application function performing unit 72 or an event processing unit 73. The application function performing unit 72 performs a process to offer a certain navigation service. The event processing unit 73 receives an event from the application control unit 23, and supplies an instruction associated with the event to the screen control request generation unit 71 and the application function performing unit 72. An interface unit 74 transfers various information between the application 24 and the external unit 5, and supplies received various information to the application function performing unit 72.

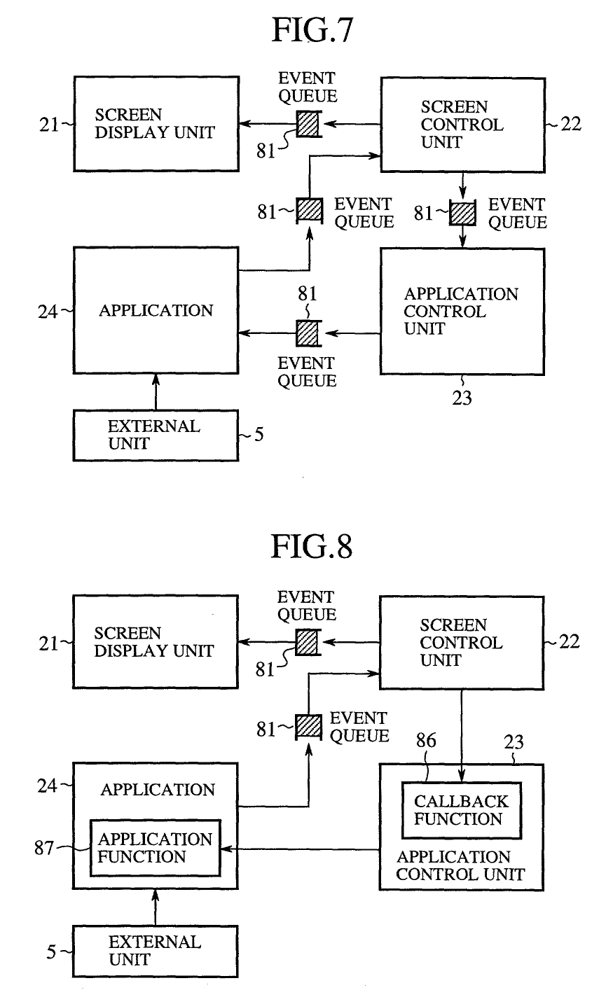

FIG. 7 is a block diagram showing transfer of an instruction from the screen control unit 22 to the application control unit 23 using an event queue, transfer of an instruction from the application control unit 23 to the application 24 using an event queue, transfer of an instruction from the application 24 to the screen control unit 22 using an event queue, and transfer of an instruction from the screen control unit 22 to the screen display unit 21 by using an event queue. FIG. 8 is a block diagram showing transfer of an instruction from the screen control unit 22 to the application control unit 23 using a call function, transfer of an instruction from the application control unit 23 to the application 24 using a call function, transfer of an instruction from the application 24 to the screen control unit 22 using an event queue, and transfer of an instruction from the screen control unit 22 to the screen display unit 21 by using an event queue. In FIG. 7, reference numeral 81 denotes each of the plurality of event queues, in which events from a supply origin are stored, for sequentially outputting the events in order of first-in first-out to a supply destination. As an alternative, it is possible to assign a priority to each event according to a fixed method, and each of the plurality of event queues 81 can sequentially output events stored therein according to their priorities. Furthermore, as shown in FIG. 8, it is possible to use a callback function 86, which is a call function, for transfer of an instruction between the screen control unit 22 and the application control unit 23, instead of the event queue 81 shown in FIG. 7, and it is also possible to use an application function 87, which is a call function, for transfer of an instruction between the application control unit 23 and the application 24, instead of the event queue 81. The callback function 86 and the application function 87 are functions to call a function corresponding to a supplied instruction.

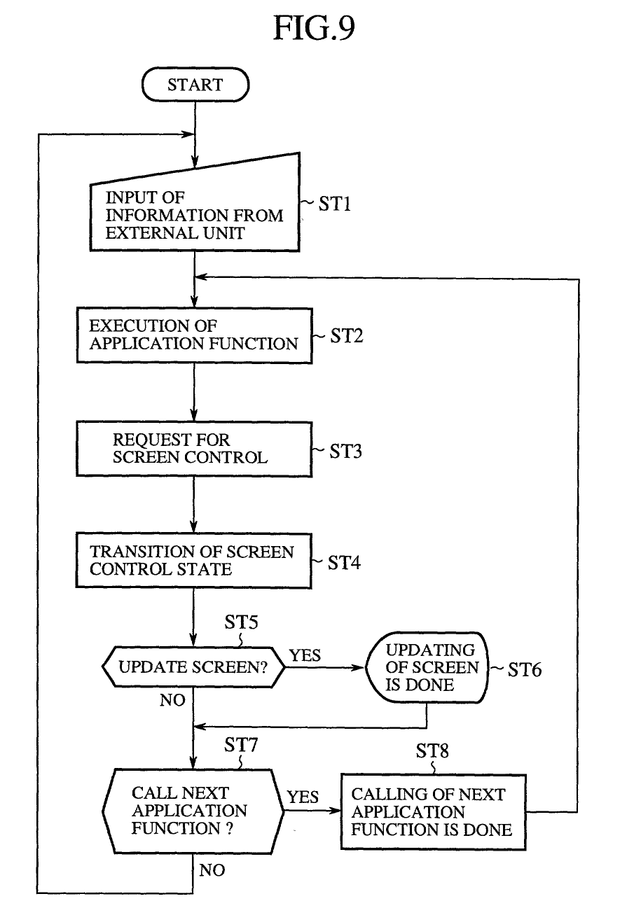

FIG. 9 is a flow chart explaining the operation of the navigation device according to the first embodiment. When one or more pieces of information are, in step ST1, supplied from the external unit 5 to the application function performing unit 72 by way of the interface unit 74 of the application 24, the application function performing unit 72 performs a process corresponding to the information in step ST2, and the screen control request generation unit 71, in step ST3, supplies a screen control request for updating of a navigation image on-screen or the like, which is associated with the processing performed by the application function performing unit 72, to the screen control unit 22.

In step ST4, the event processing unit 53 of the screen control unit 22 receives the screen control request and supplies an instruction associated with the screen control request to the internal state transition unit 52, and the internal state transition unit 52 then changes the internal state of the screen control unit 22 according to the screen control request.

Next, when the internal state transition unit 52, in step ST5, determines whether updating of an on-screen navigation image is caused by the transition of the internal state of the screen control unit 22, and it is determined that updating of an on-screen navigation image is caused by the transition of the internal state, the screen data control event generation unit 51 supplies an event associated with the updating to the screen display unit 21 in step ST6. The data output unit 26 of the screen display unit 21 then outputs screen data corresponding to the event to the display 4. Thus, an updated navigation image is displayed on the screen 31 of the display 4.

On the other hand, when any updating of an on-screen navigation image is not caused by the transition of the internal state of the screen control unit 22, the on-screen navigation image is not updated.

The internal state transition unit 52 of the screen control unit 22, instep ST7, determines whether the application control unit should call the next application function after the internal state of the screen control unit 22 has changed. When the internal state transition unit 52 determines that the application control unit should call the next application function after the internal state of the screen control unit 22 has changed, the application control event generation unit 54 supplies an event to call the next application function to the application control unit 23 in step ST8. The event processing unit 63 of the application control unit 23 receives the event from the screen control unit 22, and supplies an instruction associated with the event to the internal state transition unit 62, and the internal state transition unit 62 changes the internal state of the application control unit 23 according to the instruction, and the application function call unit 61 supplies an event to call the next application function to the application 24.

The event processing unit 73 of the application 24 then receives the event and supplies an instruction associated with the event to the application function performing unit 72 etc., and the navigation device returns to step ST2 in which the application function performing unit 72 of the application 24 performs the next application function.

On the other hand, the navigation device returns to step ST1 when the internal state transition unit 52, in step ST7, has determined that the application control unit should not call the next application function after the internal state of the screen control unit 22 has changed, and it stands by until it receives next information from the external unit 5.

After that the above-mentioned processing is repeated, and one or more navigation services are offered to the user.

As mentioned above, in accordance with the first embodiment, there is provided a navigation device whose functionality is divided into the following four modules: an application 24 for performing navigation services based on information from an external unit 5; an application control unit 23 for controlling the application 24 according to the internal state of the navigation device; a screen control unit 22 for controlling display of a navigation image according to an instruction from the application 24; and a screen display unit 21 having screen data 25, for displaying a navigation image on a display according to an instruction from the screen control unit 22. Accordingly, the present embodiment offers an advantage of being able to provide a navigation device that can be easily developed.

Embodiment 2

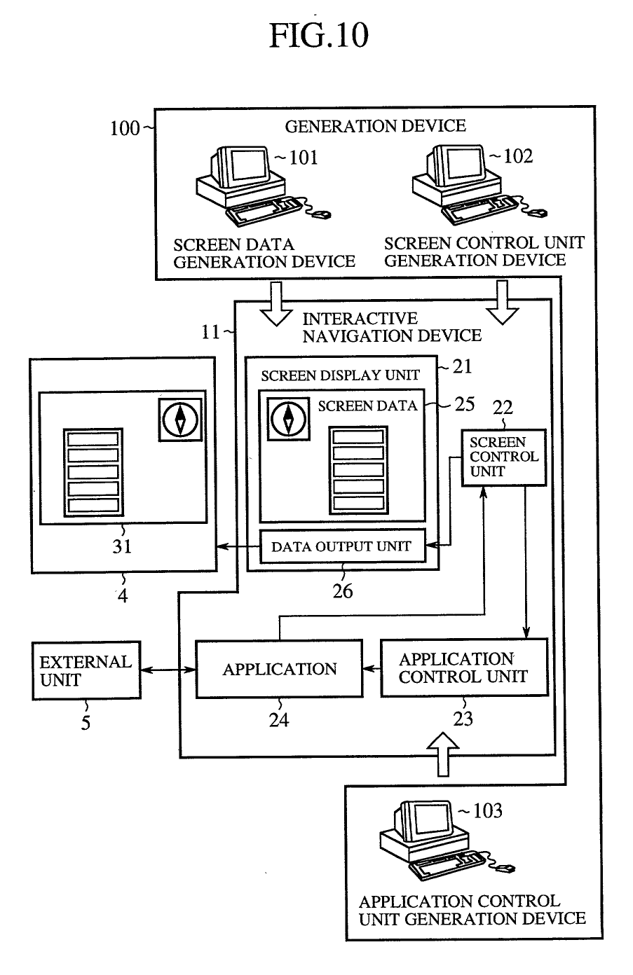

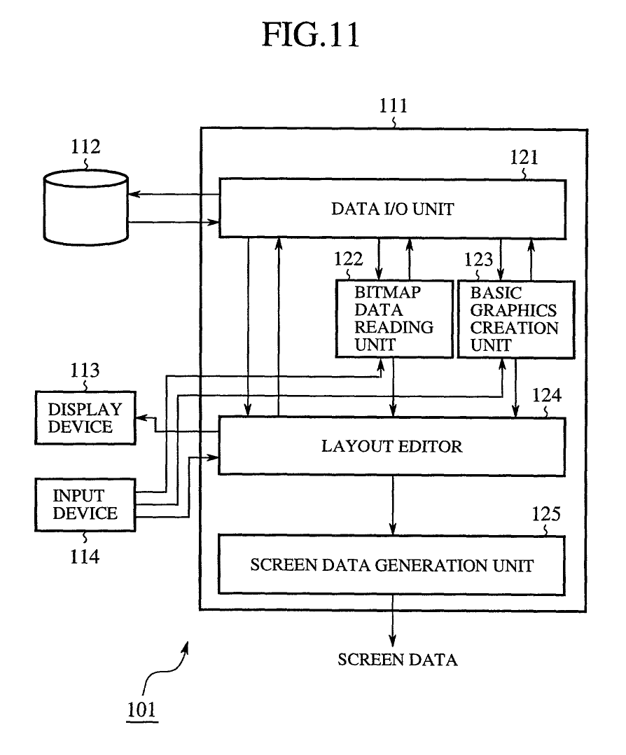

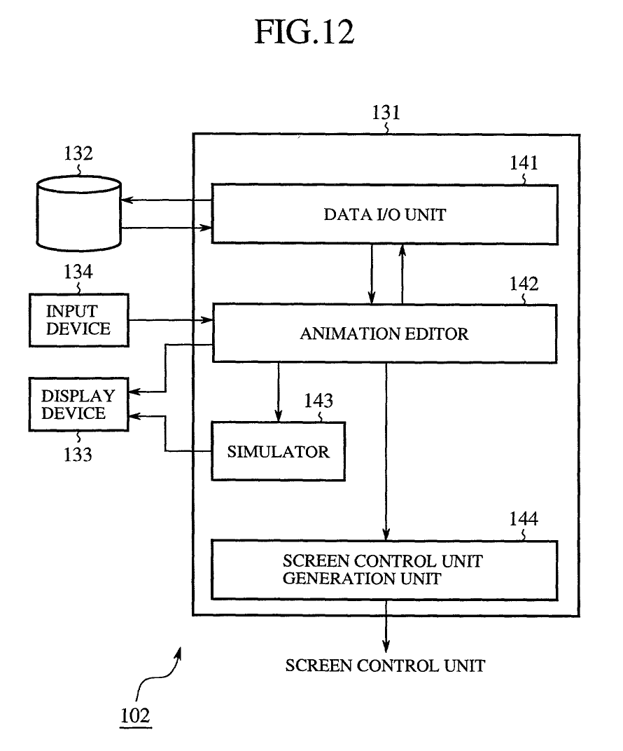

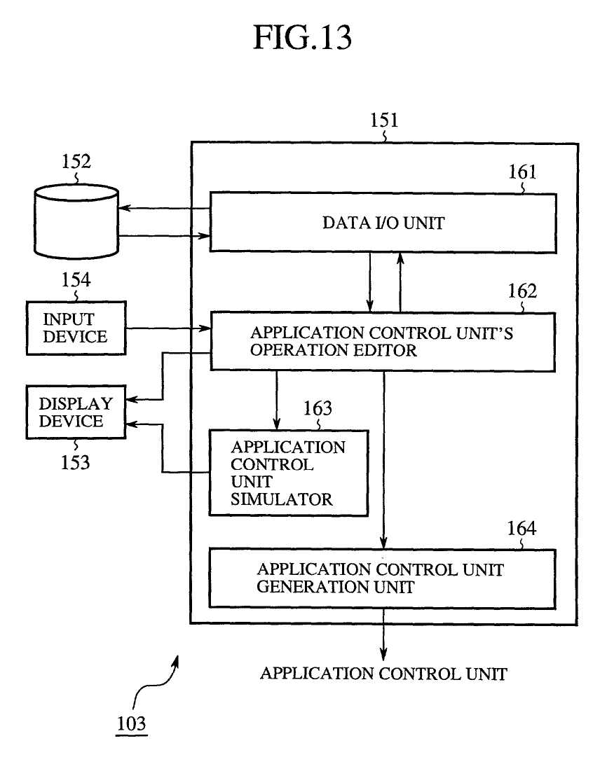

FIG. 10 is a block diagram showing the structure of a device for generating a navigation device according to a second embodiment of the present invention. FIG. 11 is a block diagram showing the structure of a screen data generation device of FIG. 10, FIG. 12 is a block diagram showing the structure of a screen control unit generation device of FIG. 10, and FIG. 13 is a block diagram showing the structure of an application control unit generation device of FIG. 10.

In FIG. 10, reference numeral 100 denotes a generation device for generating an interactive navigation device 11, numeral 101 denotes a screen data generation device for generating screen data 25 for a screen display unit 21, numeral 102 denotes a screen control unit generation device for generating a screen control unit 22, and numeral 103 denotes an application control unit generation device for generating an application control unit 23.

In the screen data generation device 101 shown in FIG. 11, reference numeral 111 denotes an information processing unit including a data I/O unit 121, a bitmap data reading unit 122, a basic graphics creating unit 123, a layout editor 124, and a screen data generation unit 125, numeral 112 denotes a storage medium, such as a hard disk drive, for storing screen data, bitmap data, basic graphics data, etc., numeral 113 denotes a display device, such as a display, for displaying one or more images corresponding to screen data under development, and numeral 114 denotes an input device, such as a keyboard or a mouse, which can be operated by a developer.

The data I/O unit 121 of the information processing unit 111 performs data I/O operations on the storage medium 112. The bitmap data reading unit 122 of the information processing unit 111 controls the data I/O 121 so as to read bitmap data which becomes parts of a navigation image from the storage medium 112. The basic graphics creating unit 123 of the information processing unit 111 creates basic graphics data by combining a circle, a quadrangle, a triangle, etc. according to operations performed on the input device 114 by the developer. The layout editor 124 of the information processing unit 111 determines the locations of one or more images consist of the bitmap data and the locations of basic graphics according to operations performed on the input device 114 by the developer. The screen data generation unit 125 of the information processing unit 111 generates screen data 25 corresponding to the one or more images consist the bitmap data and the navigation image consists of the basic graphics, both the locations of the one or more images and the locations of the basic graphics being determined by the layout editor 124.

In the screen control unit generation device 102 shown in FIG. 12, reference numeral 131 denotes an information processing unit including a data I/O unit 141, an animation editor 142, a simulator 143, and a screen control unit generation unit 144, numeral 132 denotes a storage medium, such as a hard disk drive, for storing screen data and a program written for defining the screen control unit under development, numeral 133 denotes a display device, such as a display, for displaying a chart showing the configuration of the screen control unit under development, and for displaying a series of navigation images generated when simulating the navigation device, and numeral 134 denotes an input device, such as a keyboard or a mouse, which can be operated by the developer.

The data I/O unit 141 of the information processing unit 131 performs data I/O operations on the storage medium 132. The animation editor 142 of the information processing unit 131 defines a change (display/non-display of each image component, movement, expansion/reduction, rotation, and color change, etc.) in the series of navigation images with screen data according to operations performed on the input device 134 by the developer, and designs the screen control unit (particularly, an internal state transition unit 52) via a graphic language such as a special operation descriptive language or a state chart. The simulator of the information processing unit 131 displays the series of navigation images on the screen of the display 133 one by one according to the screen control unit under development. The screen control unit generation unit 144 of the information processing unit 131 generates a screen control unit 22 based on design information from the animation editor 142.

In the application control unit generation device 103 shown in FIG. 13, reference numeral 151 denotes an information processing unit including a data I/O unit 161, an application control unit's operation editor 162, an application control unit simulator 163, and an application control unit generation unit 164, numeral 152 denotes a storage medium, such as a hard disk drive, for storing a program written for defining the application control unit under development, numeral 153 denotes a display device, such as a display, for displaying a chart showing the configuration of the application control unit under development, and for displaying a simulation result, and numeral 154 denotes an input device, such as a keyboard or a mouse, which can be operated by the developer.

The data I/O unit 161 of the information processing unit 151 performs data I/O operations on the storage medium 152. The application control unit's operation editor 161 of the information processing unit 151 designs the application control unit (particularly, an internal state transition unit 62) via a graphic language, such as a special operation descriptive language or a state chart, according to operations performed on the input device 154 by the developer. The application control unit simulator 163 of the information processing unit 151 causes the application control unit under development to operate, and displays an operation result on the screen of the display 153. The application control unit generation unit 164 of the information processing unit 151 generates an application control unit 23 based on design information from the application control unit's operation editor 162.

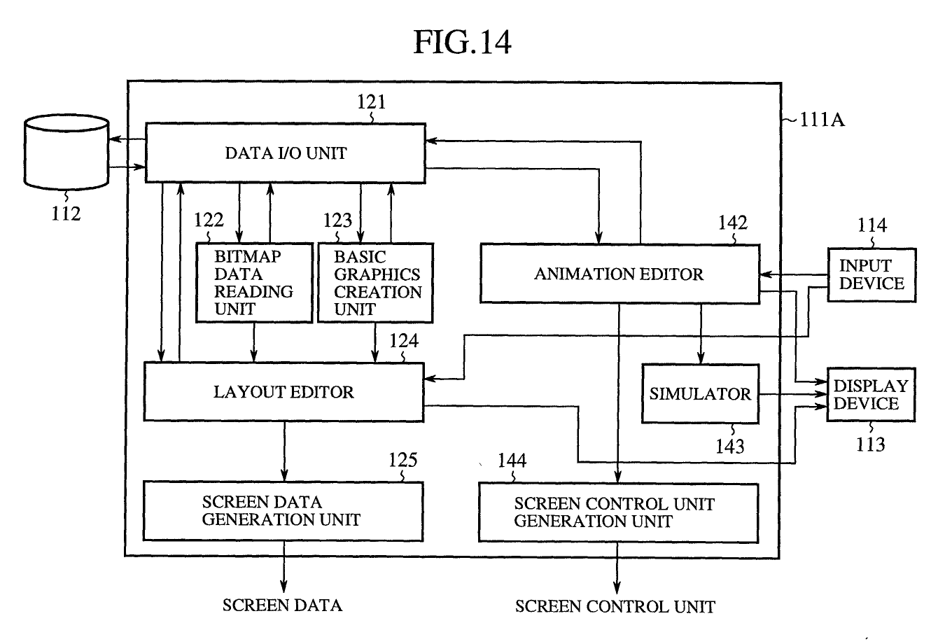

The screen data generation device 101 and the screen control unit generation device 102 can be integrated. FIG. 14 is a block diagram showing the structure of a screen data/screen control unit generation device in which the screen data generation device and the screen control unit generation device of FIG. 10 are integrated. When employing the screen data/screen control unit generation device, there is provided an information processing unit 111A including the functions of both the devices as shown in FIG. 14, and the storage medium 112, the display 113, the input device 114, and the data I/O unit 121 are used in common by both of the functions.

A computer having a microprocessor that can execute a corresponding program, memories such as a RAM and a ROM, etc. can be used as each of the information processing units 111, 131, and 151 respectively located within the screen data generation device 101, the screen control unit generation device 102, and the application control unit generation device 103.

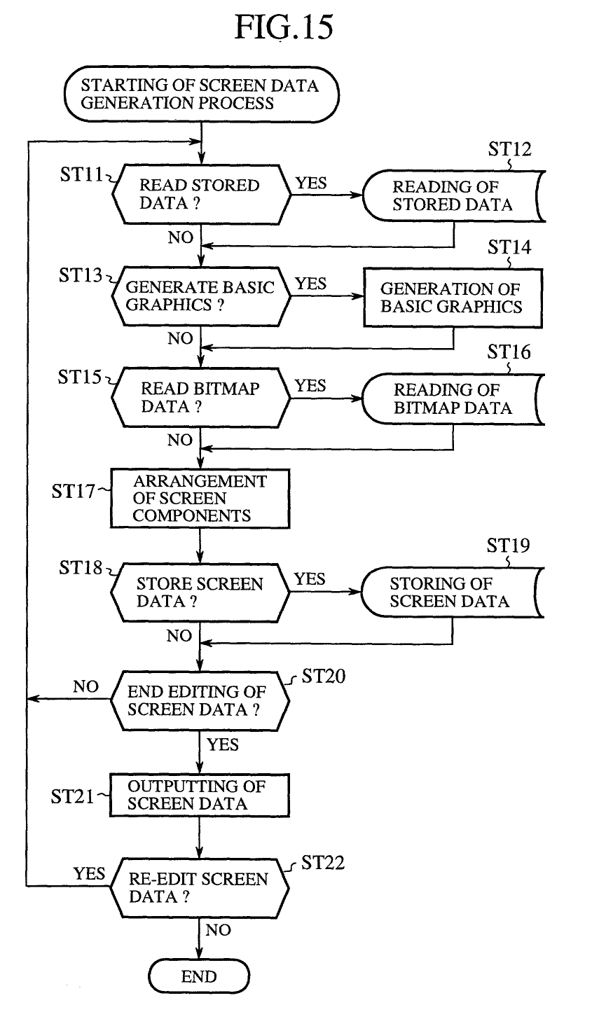

First, a description will be made as to the operation of the screen data generation device 101. FIG. 15 is a flow chart explaining the operation of the screen data generation device 101. When there is screen data under development in the storage medium 112, the layout editor 124, in step ST11, determines whether to read the screen data under development from the storage medium according to an instruction by the developer first. The layout editor 124, in step ST12, controls the data I/O unit 121 so as to read the screen data under development stored in the storage medium 112 when it has determined that it should read the screen data.

Then the basic graphics creating unit 123, in step ST13, determines whether it has been instructed to create basic graphics by the developer, and, if so, in step ST14, generates basic graphics data according to operations by the developer.

The bitmap data reading unit 122 then, in step ST15, determines whether it has been instructed to read any bitmap data by the developer, and, if so, in step ST16, controls the data I/O unit 121 so as to read the bitmap data.

Next, the layout editor 124, in step ST17, determines the locations of image components, such as images consist of the basic graphics and images consist of the bitmap data, according to operations performed on the input device 114 by the developer.

The layout editor 124 then, in step ST18, determines whether it has been instructed to store the screen data under development, and, if so, controls the developer control data I/O unit 121, in step ST19, to store the screen data under development in the storage medium 112.

The layout editor 124, in step ST20, determines whether it has been instructed to end the editing of the screen data by the developer, and, if not, it returns to step ST11 in which it continues the editing of the screen data. On the other hand, when the layout editor 124 has been instructed to end the editing of the screen data by the developer, the screen data generation unit 125, instep ST21, outputs the most-recently-edited screen data as the screen data 25 to be used by the interactive navigation device 11.

After the generation of the screen data 25, the layout editor 124, in step ST22, determines whether it has been instructed to re-edit the most-recently-edited screen data by the developer, and, if so, it returns to step ST11 in which it restarts the editing of the screen data. On the other hand, unless the layout editor 124 has been instructed to re-edit the screen data by the developer, it ends the screen data generation processing. Thus, the screen data generation device 101 generates the screen data 25.

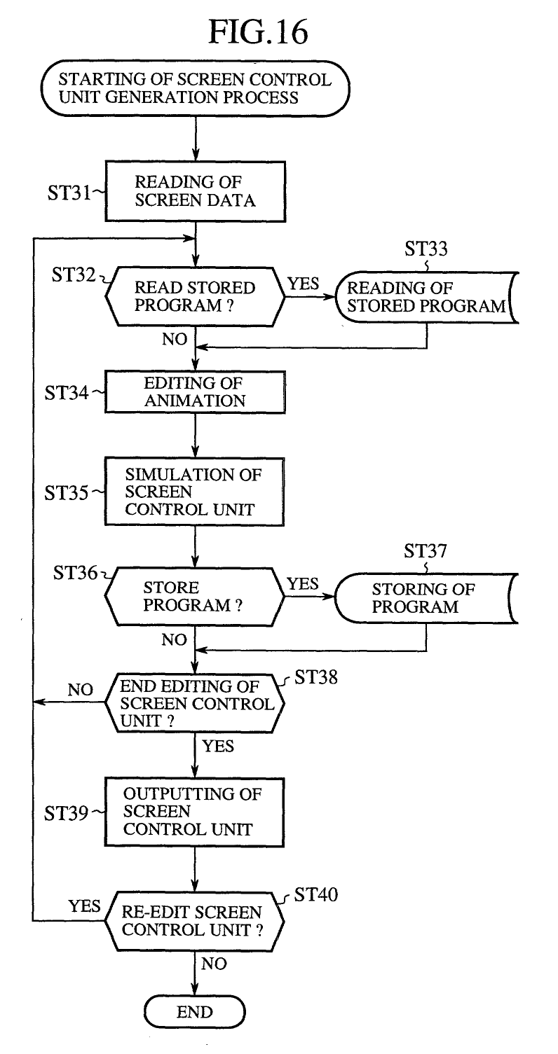

Next, the operation of the screen control unit generation device 102 will be explained. FIG. 16 is a flow chart explaining the operation of the screen control unit generation device. The animation editor 142, in step ST31, controls the data I/O unit 141 first so as to read the screen data from the storage medium 132.

Next, when there is a program written for defining the screen control unit under development in the storage medium 132, the animation editor 142, in step ST32, determines whether to read the program from the storage medium according to an instruction by the developer. When the animation editor 142 determines that it should read the program written for defining the screen control unit under development stored in the storage medium 132, the animation editor 142, in step ST33, controls the data I/O unit 141 so as to read the program.

The animation editor 142 then, in step ST34, defines changes (display or non-display of each image component, movement, expansion or reduction, rotation, and color change, etc.) in the series of navigation images with the screen data according to operations performed on the input device 134 by the developer, and designs the screen control unit via a graphic language such as a special operation descriptive language or a state chart.

The simulator 143 then, in step ST35, executes the program written for defining the screen control unit designed by the animation editor 142, and displays a navigation image corresponding to the screen data on the screen of the display device 133 according to the program.

The animation editor 142, in step ST36, determines whether it has been instructed to store the program under development by the developer, and, if so, controls the data I/O unit 141 so as to store the program written for defining the screen control unit under development in the storage medium 132, in step ST37.

The animation editor 142, in step ST38, determines whether it has been instructed to end the editing of the screen control unit by the developer, and, if not, it returns to step ST32 in which it continues the editing of the screen control unit. On the other hand, when the animation editor 142 has been instructed to end the editing of the screen control unit by the developer, the screen control unit generation unit 144, in step ST39, output the most-recently-edited screen control unit as the screen control unit 22 to be used by the interactive navigation device 11.

After the generation of the screen control unit 22, the animation editor 142, in step ST40, determines whether it has been instructed to re-edit the most-recently-edited screen control unit by the developer, and, if so, it returns to step ST32 in which it restarts the editing of the screen control unit. On the other hand, unless the animation editor 142 has been instructed to re-edit the screen control unit by the developer, it ends the screen control unit generation processing. Thus, the screen control unit generation device 102 generates the screen control unit 22.

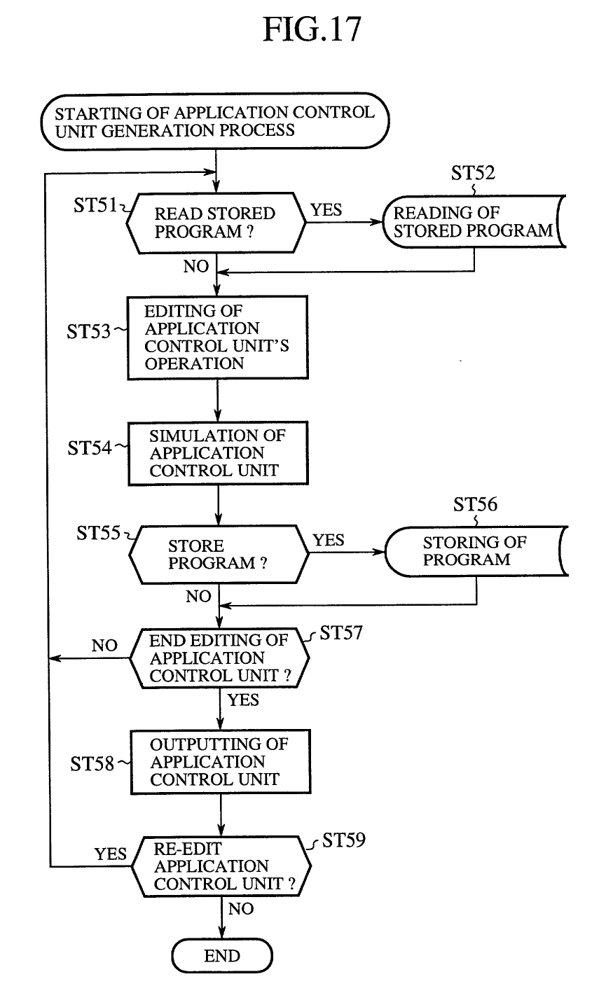

Next, the operation of the application control unit generation device 103 will be explained. FIG. 17 is a flow chart explaining the operation of the application control unit generation device. When there is a program written for defining the application control unit under development in the storage medium 152, the application control unit's operation editor 162, in step ST51, determines whether to read the program from the storage medium according to an instruction by the developer first. When the application control unit's operation editor 162 determines that it should read the program written for defining the application control unit under development stored in the storage medium 152, the application control unit's operation editor 162, in step ST52, controls the data I/O unit 161 so as to read the program.

Next, the application control unit's operation editor 162, in step ST53, defines the operation of the application control unit according to operations performed on the input device 154 by the developer, and designs the application control unit via a graphic language such as a special operation descriptive language or a state chart.

The application control unit simulator 163 then, in step ST54, executes the program written for defining the application control unit designed by the application control unit's operation editor 162, and displays an execution result on the screen of the display device 153.

The application control unit's operation editor 162, in step ST55, determines whether it has been instructed to store the program under development by the developer, and, if so, controls the data I/O unit 161 SO as to store the program written for defining the application control unit under development in the storage medium 152, in step ST56.

The application control unit's operation editor 162 then, in step ST57, determines whether it has been instructed to end the editing of the application control unit by the developer, and, if not, it returns to step ST51 in which it continues the editing of the application control unit. On the other hand, when the application control unit's operation editor 162 has been instructed to end the editing of the application control unit by the developer, the application control unit generation unit 164, in step ST58, outputs the most-recently-edited application control unit as the application control unit 23 to be used by the interactive navigation device 11.

After the generation of the application control unit 23, the application control unit's operation editor 162, in step ST59, determines whether it has been instructed to re-edit the most-recently-edited application control unit by the developer, and, if so, it returns to step ST51 in which it restarts the editing of the application control unit. On the other hand, unless the application control unit's operation editor 162 has been instructed to re-edit the application control unit by the developer, it ends the application control unit generation processing. Thus, the application control unit generation device 103 generates the application control unit 23.

As mentioned above, in accordance with the second embodiment of the present invention, there is provided a generation device for generating a navigation device, the creation device including an application control unit generation device 103 for generating an application control unit 23 that controls an application 24 for performing navigation services based on information from an external unit 5, according to the internal state of the navigation device; a screen control unit generation device 102 for generating a screen control unit 22 that controls display of a navigation image according to an instruction from the application 24; and a screen data generation device 101 for generating screen data 25 for a screen display unit 21 to display the navigation image with the screen data 25 according to an instruction from the screen control unit 22. Accordingly, the second embodiment offers an advantage of providing a development environment which makes it possible for even a person who does not have the knowledge of the programming to develop a navigation device, and which does not depend on the hardware configuration of a navigation device to be developed.

Embodiment 3

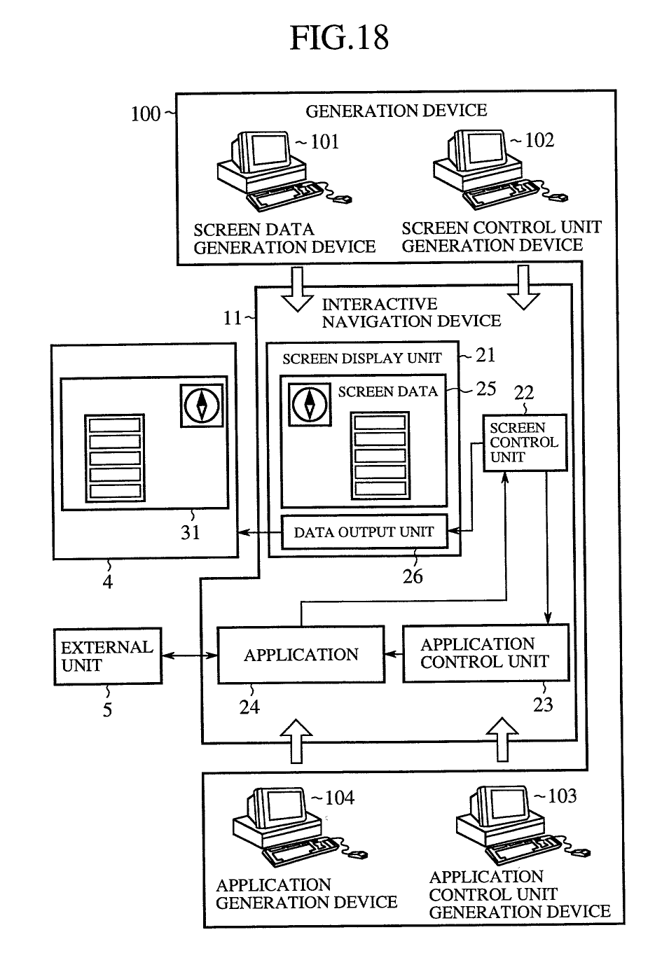

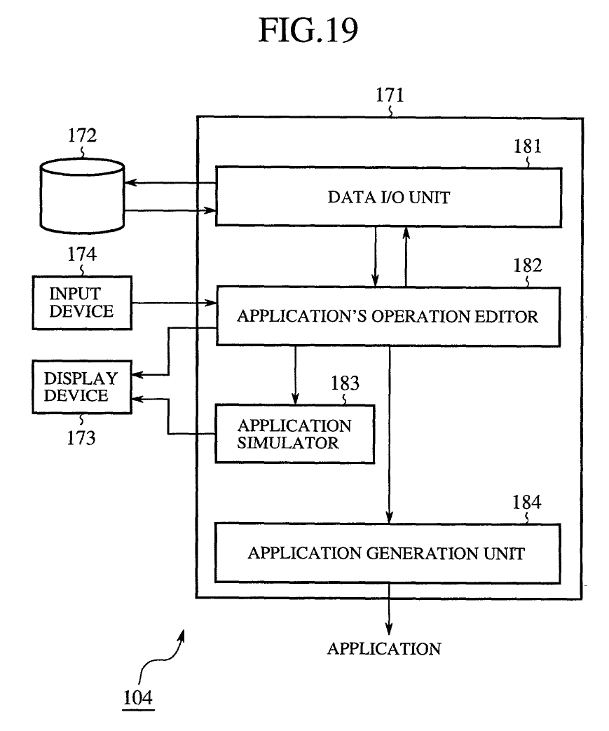

FIG. 18 is a block diagram showing the structure of a generation device for generating a navigation device according to a third embodiment of the present invention, and FIG. 19 is a block diagram showing the structure of an application generation device of FIG. 18. In FIG. 18, reference numeral 104 denotes the application generation device for generating an application 24. In the application generation device 104 shown in FIG. 19, reference numeral 171 denotes an information processing unit including a data I/O unit 181, an application's operation editor 182, an application simulator 183, and an application generation unit 184, numeral 172 denotes a storage medium, such as a hard disk drive, for storing a program written for defining an application under development, numeral 173 denotes a display device, such as a display, for displaying a chart showing the configuration of the application under development, and so on, and for displaying a simulation result, and numeral 174 denotes an input device, such as a keyboard or a mouse, which can be operated by a developer.

The data I/O unit 181 of the information processing unit 171 performs data I/O operations on the storage medium 172. The application's operation editor 182 of the information processing unit 171 designs the application (particularly, an application function performing unit 72) via a graphic language, such as a special operation descriptive language or a state chart, according to operations performed on the input device 174 by the developer. The application control unit simulator 183 of the information processing unit 171 causes the application under development to operate, and displays an operation result on the screen of the display device 173. The application generation unit 184 of the information processing unit 171 generates the application 24 based on design information from the application's operation editor 182.

The explanation of other components of the generation device for generating a navigation device according to the third embodiment will be omitted hereafter since those components are the same as those of the second embodiment mentioned above.

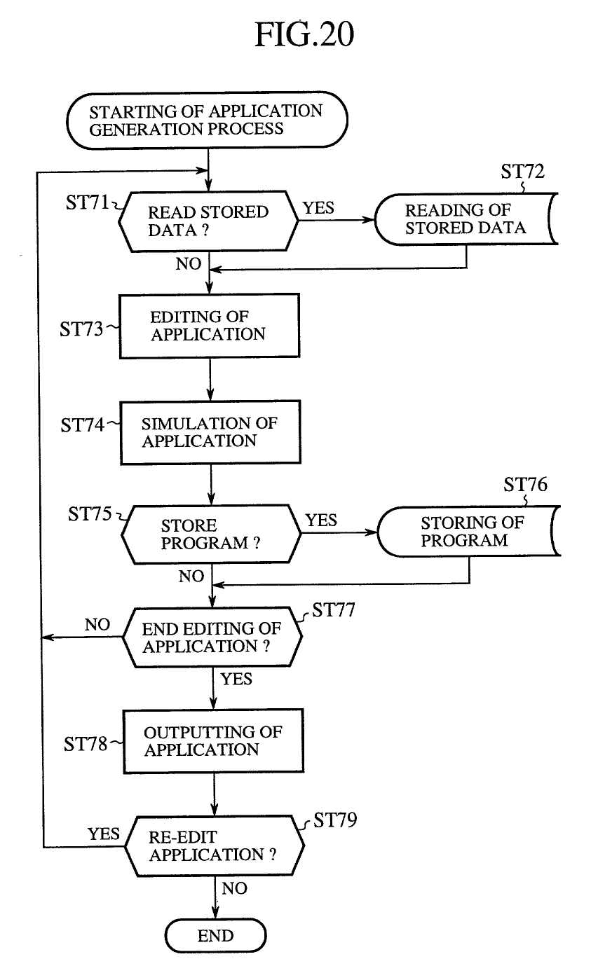

FIG. 20 is a flow chart explaining the operation of the application generation device. When there is a program written for defining the application under development in the storage medium 172, the application's operation editor 182, in step ST71, determines whether to read the program from the storage medium according to an instruction by the developer first. When the application's operation editor 182 determines that it should read the program written for defining the application under development stored in the storage medium 172, the application's operation editor 182, in step ST72, controls the data I/O unit 181 so as to read the program.

The application's operation editor 182 then, in step ST73, defines the operation of the application under development according to operations performed on the input device 174 by the developer, and designs the application via a graphic language such as a special operation descriptive language or a state chart.

The application simulator 183, in step ST74, executes the program written for defining the application designed by the application's operation editor 182, and displays an execution result on the screen of the display device 173.

The application's operation editor 182 then, in step ST75, determines whether it has been instructed to store the program under development by the developer, and, if so, controls the data I/O unit 181 so as to store the program written for defining the application under development in the storage medium 172, in step ST76.

The application's operation editor 182, in step ST77, determines whether it has been instructed to end the editing of the program written for defining the application by the developer, and, if not, it returns to step ST71 in which it continues the editing of the program. On the other hand, when the application's operation editor 182 has been instructed to end the editing of the program by the developer, the application generation unit 184, in step ST78, outputs the most recently-edited application as the application 24 to be used by the interactive navigation device 11.

After the generation of the application 24, the application's operation editor 182, in step ST79, determines whether it has been instructed to re-edit the most recently-edited application by the developer, and, if so, it returns to step ST71 in which it restarts the editing of the application. On the other hand, unless the application's operation editor 182 has been instructed to re-edit the application by the developer, it ends the application generation processing. Thus, the application generation device 104 generates the application 24.

The explanation of the other operation will be omitted hereafter since those components are the same as those of the above-mentioned second embodiment.

As mentioned above, according to the third embodiment, the creation device further includes an application generation device 104 for generating an application 24. Accordingly, the third embodiment offers an advantage of making it possible for even a person who does not have the knowledge of the programming to develop an application for navigation devices.

Embodiment 4

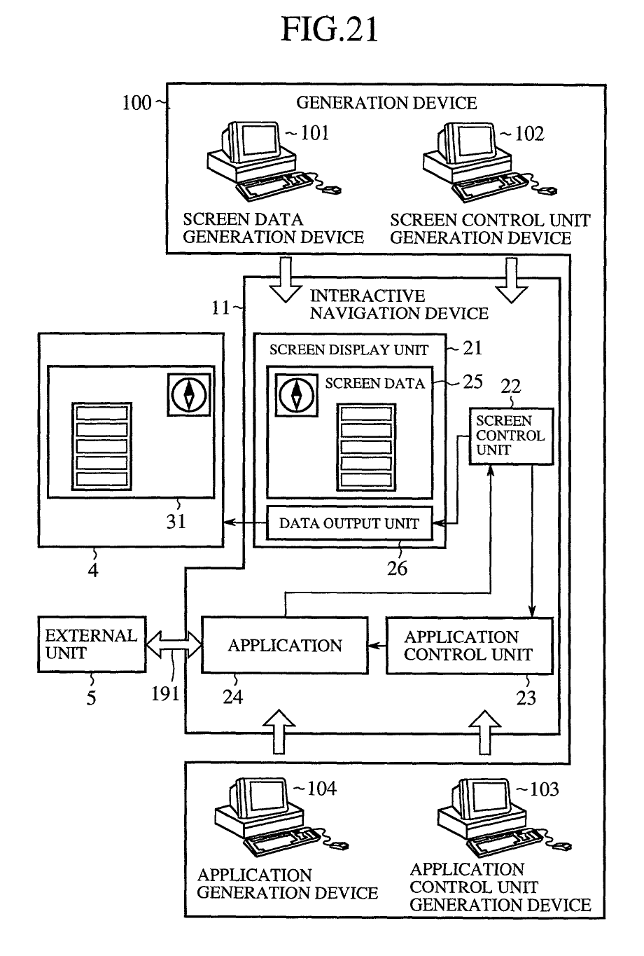

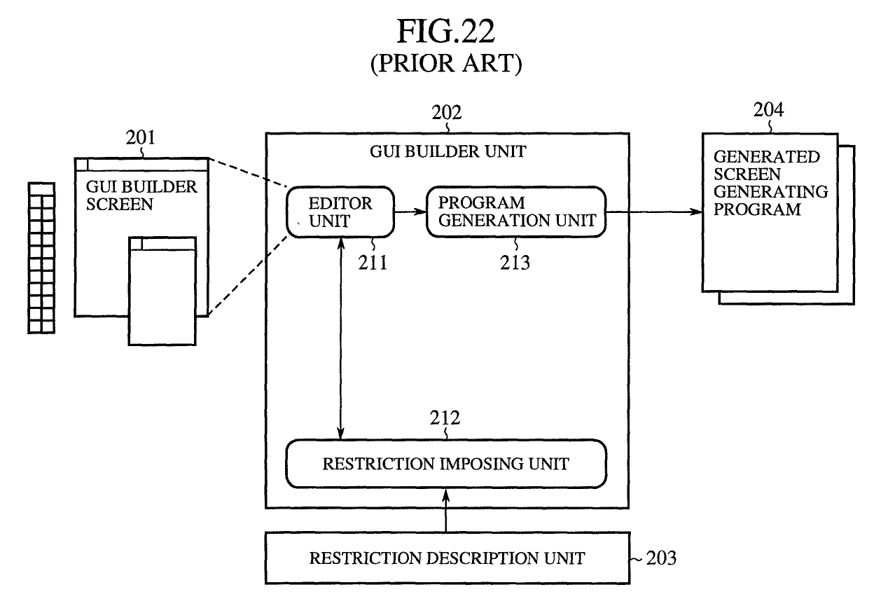

FIG. 21 is a block diagram showing the structure of a generation device for generating a navigation device according to a fourth embodiment. In the navigation device according to the fourth embodiment, an external unit 5, such as a computer for supplying data, and an application 24 are connected with each other by way of a network 191. The explanation of other components of the generation device for generating a navigation device according to the fourth embodiment will be omitted hereafter since those components are the same as those of the second embodiment mentioned above.

As mentioned above, according to the fourth embodiment, since the external unit 5 and the application 24 are connected with each other by way of the network 191, the fourth embodiment offers an advantage of being able to provide sophisticated navigation services for users by performing data communications between the external unit 5 and the navigation device.

Many widely different embodiments of the present invention may be constructed without departing from the spirit and scope of the present invention. It should be understood that the present invention is not limited to the specific embodiments described in the specification, except as defined in the appended claims.

What is claimed is:

1. A navigation device for performing navigation services, and for displaying a navigation image, wherein said navigation device is divided into the following four modules:
an application means for performing navigation services based on information from an external unit;
an application control means for controlling said application means according to an internal state of said navigation device;
a screen control means for controlling display of the navigation image according to an instruction from said application means; and
a display means for displaying the navigation image according to an instruction from said screen control means.

2. The navigation device according to claim 1, wherein said application means is connected with said external unit by way of a network.

3. The navigation device according to claim 1, wherein said screen control means can transfer an instruction to said application control means by using either an event queue or a call function, said application control means can transfer an instruction to said application means by using either an event queue or a call function, said application means can transfer an instruction to said screen control means by using an event queue, and said screen control means can transfer an instruction to said display means by using an event queue.

4. A generation device for generating a navigation device, said generation device comprising:
a first generation means for generating an application control means for controlling an application means, which performs navigation services based on information from an external unit, according to an internal state of said navigation device;
a second generation means for generating a screen control means for controlling display of a navigation image according to an instruction from said application means; and
a third generation means for generating screen data for a display means for displaying the navigation image with the screen data according to an instruction from said screen control means.

5. The generation device according to claim 4, further comprising a fourth generation means for generating said application means for performing navigation services based on information from said external unit.
